(19) United States
(12) Patent Application Publication
(10) Pub. No.: US 2010/0167020 A1
(43) Pub. Date: Jul. 1, 2010

(54) Casting Process

(76) Inventors: Ronald Jones, Brampton (GB); Raymond Todhunter, Penrith (GB)

Correspondence Address: Larson & Anderson, LLC, P.O. BOX 4928, DILLON, CO, 80435, US

(21) Appl. No.: 12/293,333

(22) PCT Filed: Mar. 20, 2007
(86) PCT No.: PCT/EP07/52649

§ 371 Date: Sep. 17, 2008

(30) Foreign Application Priority Data
Mar. 20, 2006 (GB) 0605553.7

(51) Int. Cl. B32B 3/10; B28B 5/00; B28B 1/00

(52) U.S. Cl. 428/195.1; 264/250; 264/642

(57) ABSTRACT

The freeze casting process for preparing a green shaped article such as a biocompatible bioceramic prosthesis or implant, comprises: a) providing a substrate at an initial predetermined spacing from one or more liquid dispensing outlets; b) writing a predetermined amount of a liquid formulation from at least one of the outlets onto the substrate, the formulation comprising: 8 to 99.99% by weight of a liquid sol comprising a liquid carrier and from 5 to 50% by weight, based on the weight of the carrier, of colloidally dispersed nanoparticles having a mean particle size in the range 0.25 to 100 nm; 92 to 0% by weight of a mineral powder having a mean particle size greater than 0.1 micron, and 0.01 to 10% by weight of at least one surfactant, freezing point depressant and/or rheology modifier; c) cooling the liquid formulation on the substrate so as to at least partially freeze the carrier on the cooled substrate; d) increasing the spacing between the one or more dispensing outlets and substrate to a further predetermined spacing; e) writing a further predetermined amount of the liquid formulation from at least one of the outlets either on to the substrate or on to deposit formed in steps b) and c) f) cooling the liquid formulation so as to at least partially freeze the liquid carrier on the substrate and/or on the deposit; and g) optionally repeating steps (d), (e) and (f) one or more times.

### BACKGROUND TO THE INVENTION

The present invention relates to a freeze casting process using ceramic materials or the like, enabling production of complex articles such as those required in medical applications such as implants and prosthesis.

Ceramic materials intended for uses such as bone scaffolds and the like are known as bioceramics; they offer particular advantages for the production of implants compared with more conventional metallic materials such as cobalt, chromium or titanium. Bioceramic materials can be tailored to be fully resorted over time and thus be replaced with natural tissue. Bioactive rather than simply biocompatible implants are preferred because they eliminate the risk of long term rejection and other associated complications. Bioceramics can be implanted into bone fractures in place of missing bone. A first category of bioceramics is in the form of highly porous scaffolds having biocompatible body-soluble compositions which allow bone to grow through the scaffold or eventually dissolve the implant leaving natural bone. Generally these implants are made from hydroxyapatite (HAP) or tri-calcium phosphate (TCP); growth enhancing proteins can also be introduced into the pores of the ceramic to accelerate the growth process.

A second category of bioceramics is mechanically strong; such bioceramics act as support in the fracture zone, permanently replacing the missing bone. These implants are either fully dense structural ceramics such as aluminium oxide or zirconium oxide or may contain some porosity to allow the existing bone to grow into these pores and bond strongly to the implant.

Forming the external geometry is very important. It is desirable to use a non-invasive technique such as an x-ray or CAT scan to reveal the geometry of the fracture area and then to produce a computer model of the optimum bone implant required. This computer model can then be used to build the actual implant by a rapid manufacturing process such as direct writing which includes three dimensional printing. The accuracy of the external geometry is important since it will minimize any reshaping by the surgeon necessary to ensure good fit and therefore reduces the operation time, thereby reducing the risk of infection. Equally important is the formation of internal geometry. Natural bone has interconnected pores and channels through which blood flows carrying nutrient to the bone. FIG. 1 of the accompanying drawings is a micrograph of a section of human bone.

Methods for manufacture of artificial bone implants must be capable of building, not only the external geometry, but also the internal microstructure.

The term “direct write” is used to describe the use of rapid prototype and manufacturing techniques whereby the geometry of the component to be made is represented by a series of layers or laminations; and under the control of a computer, each layer is built one on top of the other. The computer controls either a printing head or a dispensing head and guides the delivery of the liquid material so as to build that layer. The computer then either moves the component being built or the printing/dispensing head away from the first layer by the required layer thickness and the next layer is deposited on the previous layer and so the component is built up. Each layer thus corresponds to a cross-section or slice through the macroscopic object; an example of such an object is illustrated schematically in FIG. 2 of the accompanying drawings, in which there is shown a succession of layers 1,2,3,4,5,6, 7,8, 9,10,11 and 12, built up in such a way that channels 13, 14 are formed in the resulting body.

This technique is a fairly recent development and has been adapted to various materials including ceramics. Ceramic slurries can be dispensed through units that either extrude a stream of material or print discrete drops. The computer model of the object being made is sliced into a series of laminations. The computer then either controls the movement of the dispenser or substrate on which the object is built and writes the layer. Each layer thus corresponds to a cross-section or slice through the macroscopic object.

The state of the art uses ceramic slurries (inks) that are generally prepared with binder systems which solidify as the material is deposited in order that it retains its accurate geometry. Two systems have been used in which the ceramic powders are held in suspension, either in a molten thermoplastic-containing binder or a solvent-containing binder. In the former case the deposited material becomes solid as it cools and sets and in the latter case the materials loses solvent thus setting the binder. After the component is built, the ceramic particles are held via the polymeric binder. This must then be carefully burnt out after which the temperature can be increased and the ceramic particles strongly bonded together.

The principal disadvantages of both methods are:
1. The removal of the binder has to be very carefully controlled and can lead to distortion of the component.
2. The amount of solid that can be introduced to the binder is limited so that, after burn, out the component has a high level of porosity and when this is sintered to generate strength, the component shrinks considerably leading to a further factor that makes “net shape” control difficult to achieve.
3. Polymer burn out means that issues of VOC (volatile organic compound) emissions need to be dealt with in an industrial environment.

Freeze casting (freeze gelation) is a commonly employed method of manufacturing high integrity technical ceramic parts such as crucibles and kiln furniture, pouring cups, nozzles, orifice rings and many other components used in high temperature processing of metals, glass and ceramics. The conventional (bulk) freeze casting method, employed by ceramic and refractory manufacturers, has been used to produce monolithic bioceramic implants with precise external geometry. However, not only does this method require manufacture of a complex mould to form the external shape but also the internal structure, such as the various complex pores in bone ranging from 20 to 500 microns, cannot be precisely controlled by the freeze casting approach without the introduction of removable cores that replicate these pores

In a conventional freeze casting process, ceramic powders of carefully selected particle sizes (typically silica, alumina or silicon carbide) are mixed with a sol (a stable suspension of nanoparticles) typically an aqueous colloidal suspension of silica. After introducing the resulting slurry into a mould it is rapidly cooled to typically minus 50° C. The sol is solidified during the freeze process by an irreversible transformation of the colloidal dispersion undergoing a sol-gel transition. Hence the material remains solidified even when it is heated to room temperature. Normally, the green part produced would be subsequently fired in order to develop strength. The main advantages of freeze casting relative to other ceramic processes are that the green casting has high strength and makes it easy to handle and set in the kiln for firing. Due to the very strong bonds formed between the sol particles, including those adsorbed on the surface of the larger ceramic particles, the equivalent of an internal pressure is chemically induced and which draws all particles together around the ice crystals as if external pressure had been applied, for example, in isostatic or dry pressing. It is known that in sintering ceramics the more densely and strongly bonded the particles are in the unfired (green state) the less the component shrinks on firing. This is born out by typical manufacturing shrinkages of 0.4% for freeze cast components as compared with up to 20% shrinkage for other processes such as slip casting. Also because the internally generated pressure is uniform the component does not distort on drying particularly if it comprises uneven section thicknesses.

However, to cast medical implants from X-ray data would require a mould to be made for every fracture for which the bone implant is required. Additionally conventional mould based freeze casting will not allow any control over the internal structure of the component.

### DESCRIPTION OF INVENTION

There is a need for a process in which green parts are produced with high green density and without appreciable shrinkage after firing. There is also a need for a process which does not require a mould to be made every time a product such as a bone implant is formed. There is also a need for a process which will allow complex internal geometry to be achieved. It is also desirable that the end product should have a good mechanical strength if it is required to be load bearing, for example when the product is used a bone implant for aiding recovery from a fracture.

The present invention satisfies some or all of the above aims. In particular, the present invention is capable of providing high strength green cast parts with complex internal geometry. This can be achieved without the need for a mould to determine the external geometry and without the need for removable parts such as cores to generate internal geometry. Such advantages cannot be achieved in a conventional freeze casting process.

According to the invention there is provided a process for preparing a green shaped article, the process comprising the following steps:

a) providing a substrate at an initial predetermined spacing from one or more liquid dispensing outlets;
b) writing a predetermined amount of a liquid formulation from at least one of said outlets onto the cooled substrate, said formulation comprising:
8 to 99.99% by weight (such as 20 to 99.9%, or 20 to 95%) of a liquid sol (a colloidal liquid) comprising a liquid carrier and from 5 to 50% by weight, based on the weight of the carrier, of colloidally dispersed nanoparticles having a mean particle size in the range 0.25 to 100 nm;
92 to 0% by weight (such as 5 to 92%, or 5 to 80%), or of a mineral powder having a mean particle size greater than 0.1 micron, and
0.01 to 10% by weight (such as 0.1 to 10%) of at least one surfactant, freezing point depressant and/or rheology modifier;
   c) providing cooling to said liquid formulation on the substrate so as to permit at least partial freezing of the carrier on the cooled substrate;
   d) increasing the spacing between the one or more dispensing outlets and substrate to a further predetermined spacing;
   e) writing a further predetermined amount of the liquid formulation from at least one of said outlets either on to the substrate or on to deposit formed in steps b) and c)
   f) providing cooling to said liquid formulation on the substrate or on the deposit so as allow at least partial freezing of the liquid carrier on the substrate and/or on the deposit; and
   g) optionally repeating steps (d), (e) and (f) one or more times.

The writing in step b) and/or in step e) involves depositing the relevant formulation to a desired depth on the substrate or, in step e), on the deposit.

The process according to the invention therefore comprises a freeze casting process, in which layers are successively built by freeze casting.

The process of the invention allows the production of sintered or fired parts which have substantially identical dimensions to the unfired green part. This is a significant advantage in that the initial casting can be made to the exact dimensions required and it is not necessary to undertake complex calculations to determine the amount of shrinkage that will occur during firing. Equally, it is not necessary to overcompensate by producing a part which is slightly too large and then machine or otherwise work the part to produce a part of the desired size and shape. This is a significant advantage in the process of the present invention over known direct write processes used to print ceramics because such processes require the use of polymeric binders which leave a very weak and low density green parts, when the binder is removed, and which lead to significant shrinkage on firing. The process according to the invention also reduces the amount of handling that is necessary for the resulting article.

The process according to the invention takes advantage of the Van der Waals binding forces between very small particles which are able to interact once the liquid carrier (such as water) between the sol nanoparticles is removed in the freezing operation. It is liquid carrier molecules that separate the sol nanoparticles and stabilize the sol. Once the liquid carrier barrier is removed, the nanoparticles can get close enough together to enable Van der Wails forces to attract the nanoparticles together.

In the present invention, the liquid formulation as described above is loaded into a dispensing system which allows either a thin stream of material, or discrete droplets, to be dispensed onto a surface via dispensing outlets such as nozzles. The surface and/or the point of contact with the surface are then chilled to effect freeze casting. The dispensing outlets can be inkjet printing heads, micro dispensers such as syringes, miniature peristaltic pumps, pressure activated dispensers or other such apparatus allowing controlled amounts of material to be delivered to required locations on a surface or substrate as either discrete droplets or in a continuous stream. The position of the dispenser outlets relative to the substrate and the volume of material delivered are carefully controlled in order to achieve sufficient resolution to achieve the required external and internal geometry and dimensions. For example, such control may be provided by pre-programmed control means such as a microprocessor, which includes a memory in which is stored information relating to shape, internal geometry, dimensions and the like of the desired cast green part). The liquid formulation used in the process according to the present invention comprises from 8 to 99.99% by weight of the formulation of a sol containing 5 to 50% by weight of colloidally dispersed nanoparticles having a mean particle size in the range 0.25 to 100 nm;

mineral particles present in the sol in an amount of 0 to 92% by weight of the formulation, and further
0.01 to 10% by weight of the formulation of one or more additives which may be surfactants (such as anionic cationic or non-ionic surfactants), rheology modifiers or controllers such as water, or freezing point depressants such as glycerol.

In step c) and/or f) of the process according to the invention, cooling may be applied to a point or other location on or near the substrate at an initial predetermined spacing from one or more liquid dispensing outlets; alternatively the substrate itself may be cooled.

The liquid sol formulation is cooled to a temperature below that at which its carrier freezes in step c) and step f) in order to effect solidification of the formulation into the form of a shaped article and irreversible bonding between the sol particles. It is not necessary to apply pressure when forming the shaped article. Typically, the freeze casting according to the invention is effected with cooling to a temperature from minus 5 to minus 196° C., the latter being the temperature of liquid nitrogen. Conveniently, liquid nitrogen or other well known cooling systems such as liquid carbon dioxide or cryogenically cooled liquids such as isopropyl alcohol or silicone oil may be employed.

It is preferred that liquid nitrogen be applied to the formulation contacting the substrate or previously deposited layer in the form of a fine jet of liquid The latent heat in conversion from liquid to gas provides much higher heat transfer than simply cooling with cold gas. Freezing is more rapid and results in smaller ice crystals which give the ceramic a preferred microstructure.

When freezing using cold liquids, the dispensing outlet generally writes the slurry onto the substrate or previous layer, which may be totally or partially immersed in the cold liquid.

In steps b) and/or e), the predetermined amount is preferably controlled by a microprocessor which acts on the or each respective liquid outlet (the latter being typically a printer head driven by a motor controlled by the microprocessor).

Steps b), d) and/or e) are preferably controlled by memory means storing information relating to shape, internal geometry and dimensions of the desired green shaped article.

The formulation is preferably written onto the substrate in step b) and/or in step e) in the form of droplets.

The colloidally dispersed nanoparticles used to form the colloidal sol are preferably of materials which are at least biologically innocuous, and more preferably of materials which are biocompatible when present in a human or animal body. Examples of preferred materials are selected from silica, alumina, carbon, zirconia, yttrium oxide, titanium dioxide, hydroxyapatite, or mixtures of two or more of these materials. For use in the process of the present invention, the particles have a mean particle size in the range 0.25 to 100 nm, more preferably the mean particle size is in the range 1 to 40 nm. The sols may be prepared via a variety of routes including ion exchange, high shear dispersion, hydrolysis of alkoxides, precipitation techniques and various forms of combination such as attrition milling.

Without wishing to be bound by theory, it is believed that the success of the process according to the invention is due to the presence of the nanoparticles.

The formulation generally also contains a relatively coarser mineral powder having a mean particle size typically within the range of at least 0.1 microns, such as 0.1 to 800 microns when the process is used for production of a bioceramic component. Coarser powders can be used for other components and the relation between maximum particle size and resolution of the features required to be formed in the component is that the mean diameter of the particles should preferably be no greater than 10% of the size of the feature. However, resolution of such a feature will be optimum when the mean diameter is no greater than 2%.

It is preferable to blend such mineral powders from a range of grain sizes so that holes remaining in the structure of the coarsest powder may be filled with grain sizes equal to their diameter, and the holes in this structure get filled with the next size down and so on for four levels of ceramic grain sizes. In such a case, each of the four (or other number of levels of sizes that may be used) sizes of powder has a mean particle size in the range of 0.1 to 800 microns. Formulation of the grain size mixture should follow standard best practice in ceramic manufacture as would be adopted in more conventional processes such as slip casting.

The mineral powder when present generally forms a slurry with the sol; the preferred amount of the mineral powder depends on the total surface area of all the particles in the mix (usually expressed on m² per gm) and the surface charge on the particles. This ratio of powder to sol will also be influenced by the presence of dispersing and wetting agents. The extremes of the ratios possible can be expressed as a range of:

8 to 99.99 wt. % sol

92 to 0 wt. % mineral powder.

The sols are generally clear or slightly opaque low viscosity liquids containing 5 to 50 weight % of nanoparticles and can be written according to the invention entirely without the mineral powder, but the height of such structures will be limited and the process then might be used to produce a layer structure rather than a true 3-D object.

It is believed that when the formulation is frozen, ice crystals begin to form initially (when the carrier consists essentially of water) and these crystals exclude sol nanoparticles from the freezing liquid, just as salt is excluded from sea water in desalination. As these nanoparticles move away from the site of ice crystal formation, they can accumulate at the surface of the ice crystals and where they are adsorbed on the coarser mineral particles when present. The reason for this may be that there are no barriers to prevent close approach and they are then able to bond by the attraction of Van der Waals forces. The small size of these nanoparticles thus allows them to get very close to one another with the effect that they overcome the electrostatic repulsion that normally separates particles.

Such strong bonding between sol nanoparticles and between sol nanoparticles and the coarser mineral particles generates internal attractive forces that are similar to those that would be generated by the application of external pressure to the slurry. Hence it is not necessary to contain the formulation in an external containment such as a mould. Whatever shape is generated from the dispensing outlet (such as an ink jet head) will become the solid geometry after freezing. It is thus important that the thickness of the stream of material or the diameter of the droplets is an order of magnitude smaller that the finest geometrical feature required in the final formed article (such as a bone implant).

In order for this process to work it is important that the mean particle size of the nanoparticles is less than or equal to 100 nanometres. The lower limit of the mean particle size is preferably 5 nanometres.

The coarse mineral powder has a mean particle size of greater than 0.1 μm and can be any suitable mineral powder; such a material should be one which generally has insufficient interparticle bonding to form a self-supporting body. There may be a distribution of particle sizes in the coarse ceramic powder in the same way as would be used in more conventional processes, and as described above. Particularly preferred mineral powders are of materials which are at least biologically innocuous, and more preferably of materials which are biocompatible when present in a human or animal body. Examples of preferred materials are selected from: alumina, silica, zircon, zirconia, silicon carbide, silicon nitride, porcelain (especially dental porcelains), glass-ceramic, tribalism phosphate (TCP), hydroxyapatite (HA). Other possible materials include spinel, mullite, titanium dioxide, calcium silicate, carbon, ceramic fibres including fibres made from silica, alumina, and aluminosilicates; carbon nanotubes, glass ceramics, cordierite, metal powders, glass powders, barium titanate, lead zirconate titanate, yttrium oxide, yttrium barium copper superconducting powders, and metal oxide powders including chromium oxide and magnesium oxide. The powder may be a mixture of one or more of the above materials. Particularly preferred materials include ceramic materials such as aluminium oxide, silica, zirconia, silicon carbide, silicon nitride, tricalcium phosphate and hydroxyapatite, as well as refractory materials such as carbon, metals or glass.

It is particularly preferred that the nanoparticles used to form the colloidal sol and the mineral powder should have substantially identical chemical compositions. When both the nanoparticles and the mineral powder are of ceramic, the resulting green article is typically a bioceramic material.

When the process according to the invention is used to produce implants, they may be designed to re-dissolve in the body once bone growth has initiated; hence compositions incorporating tricalcium phosphate and or hydroxyapatite are preferred for such applications and such compositions can be fired at low temperature to yield a low strength body. The liquid content of such compositions would be high since these ceramics require a high degree of porosity through which the growing bone can pass. Since porosity in freeze cast ceramics is generated by the eventual drying out of the liquid from the melted previously frozen crystals (for example, of ice), then high liquid content is required.

Some implants are intended to be put in place as load bearing members (for example hip joints); these require high strength and toughness. Suitable compositions for these implants would be alumina and zirconia. In addition to medical applications others amongst the above materials may be particularly preferred for use in applications where their intrinsic properties are beneficial. Structural ceramic powders may find use in automotive applications for the manufacture of ceramic tooling; for example.

The shaped green article produced in the process of the present invention can be fired (or sintered) using any suitable conventional process to produce the finished article. Thus the process of the present invention may include the further step of heating the shaped article to produce a sintered product. Such a sintered product has substantially the same dimensions as the shaped article and benefits from high strength and good structural integrity. This represents a significant advantage because currently the use of ceramic materials in biomedical applications is hampered by the lack of flexible, cost effective and reliable processing methods. The problem is further exacerbated when the products are highly complex and manufactured in small numbers. The present invention therefore provides a process which offers a more efficient and cost effective and flexible manufacturing route.

The present invention therefore further comprises a biocompatible prosthesis or implant, which comprises a monolithic body built up as a plurality of layers at least some of which are discontinuous, each said layer being formed from nanoparticles of mineral material, and optionally mineral powder, bonded together essentially by Van der Waals forces and being substantially free of organic binders. The present invention furthermore extends to a formulation for use in the manufacture of a biocompatible prosthesis or implant, the formulation comprising:

8 to 99.99% by weight of a liquid sol comprising a liquid carrier and from 5 to 50% by weight, based on the weight of the carrier, of colloidally dispersed nanoparticles having a mean particle size in the range 0.25 to 100 nanometres;
92 to 0% by weight of a mineral powder having a mean particle size greater than 0.1 micron; and
0.01 to 10% by weight of at least one surfactant, freezing point depressant and/or rheology modifier.

Conventional direct write of components uses ceramic powders and a binder such as a polymer. The polymer holds the ceramic particles together until the component is fired in a furnace and the polymer is burnt away leaving the sintered ceramic particles to form the shaped article. However, such products have very low density and since sintering only takes place between particles that actually make physical contact, this results in structures with low mechanical strength as a whole. It is only possible to increase the strength by sintering at such a high temperature that the porosity is significantly reduced. However, this is accompanied by high shrinkage, which can lead further to loss of integrity through cracking and distortion. The present invention overcomes these disadvantages because a green shaped article according to the present invention can have a relatively higher area of contact between particles than is the case in conventional direct write processes.

The present invention therefore provides a process which allows binding of the mineral powder (when present) substantially instantly. In addition, the green shaped articles of the present invention have the advantage than when they are returned to room temperature, ice crystals melt away (when the liquid is water) and the water dries out leaving a porous structure which has a sufficiently high density around the pores that little or no shrinkage takes place after sintering. A further advantage of the process of the present invention is that the green product can be sintered directly after drying and no “burnout” process is required as is required in the case of a ceramic held together with polymeric binder. Polymeric binder burnout is notoriously difficult to achieve without distortion of the ceramic component and is a time consuming process. There is also the disadvantage of it leading to the emission of VOCs (volatile organic compounds) to the atmosphere.

In the present invention essentially the only emissions resulting from the process are the solvent in the sol, which is generally water, and the cooling gases such as nitrogen.

The process of the present invention allows a higher density to be achieved than is the case with conventional direct write process because as the sol excludes the liquid carrier such as water on freezing (due to ice crystal formation) the nanoparticles become close enough together for Van der Waals forces to interact and pull the particles close together. If other coarser mineral particles are mixed into the sol, the freeze gelation effect acts as a binder system pulling all the particles closely together. This is achieved with a pressure similar to that which could be applied externally through processes such as isostatic processing. However, no externally applied pressure is required in the process of the present invention.

A further advantage of the process of the present invention is that the shaped articles produced in the process can be fired or sintered at lower temperatures than are conventionally employed because of the reactive nature of the sol nanoparticles. It is also envisaged that in certain circumstances the shaped article in its green form may be sufficiently strong to be used form without the need for further processing, such as sintering. This leads to the possibility of forming implants for medical use which have growth factors deposited within or on the surface of the implant. Suitable growth factors are those such as BMP-7. One advantage of this approach is that it avoids the extremely costly approach of flooding the implant area with BMP-7, the majority of which is expelled from the body within 48 hours. These growth factors would not be significantly damaged in the freezing process.

The liquid formulation can, as indicated, include relatively high proportions of the mineral particles.

The additives present may serve to wet the surface of the mineral particles allowing a high particle loading. Ionic surfactants (such as those based on polyacrylic acids) assist in the solid loading of the slurry composition by adsorbing on the surface of the mineral particles and attracting water molecules to the surface. Ceramic powders such as silicon carbide have no significant surface charge and therefore disperse well with non-ionic surfactants. Non-ionic surfactants include those based on polyethoxylated alcohols and oils.

During freezing (steps d and f) it is desirable to create small equiaxed ice crystals so that on removal of the ice, the pores remaining are small compared to those being “written” in to the structure and do not interfere with this internal geometry. The most common additive for this purpose is glycerol which allows a degree of supercooling below the normal freezing point to take place when water is used as the carrier, as is preferred. The greater the supercooling before solidification occurs, the greater the nucleation density of ice crystals which form at the reduced freezing temperature; this limits the size that ice crystals can achieve. The rheology can be adjusted with other additives such as viscosity modifiers which include vinyl acetate-vinyl chloride-ethylene copolymers, ethylene-vinyl alcohol copolymers, silane modified polyvinyl acetate, methyl ethyl cellulose, carboxymethylcellulose and polyacrylic acid together with pH modifiers including nitric, citric, acetic or lactic acid if so required.

The control of rheology is complex because it relates not only to the additives listed above but also the particle size distribution, chemical nature and surface area of the mineral powders. Such materials can be added to give the slurries non-Newtonian behaviour allowing the materials to undergo “sheer thinning, shear thickening and dilatant” behaviour. This controls how the materials pass through very small apertures used in the dispensing outlets to produce “direct write” ceramic parts using dispensing outlets such as syringes, pumped slurry or inkjet printing heads. In particular slurries that are “dilatant” appear to lower their viscosity under vibration which can assist them to flow.

Shaped articles produced by the process of the present invention may be used in several different applications where precise control of geometry and strength is required. Thus the process may find use in the preparation of articles for medical applications, engineering applications, electronic applications and ornamental applications. For example, components that can be made by a direct writing process include small high precision components for use as dental prosthetics, electronic components, piezoelectric and dielectric structures on ceramic or metal substrates, computer print heads, antennae for mobile phones and other wireless applications, substrates for hybrid circuits and sensors, bio-soluble implants and jewelry.

Larger components that can be made using the process of the present invention include bone scaffolds, biocompatible prosthetics, domestic ceramics such as. crockery, ornamental artistic ceramics, complex components requiring fine geometrical features such as holes, slots, threads, mesa's and platforms and piezoelectric devices including ceramic fuel injectors, components for fuel cells and dies and tooling for a wide range of forming processes, particularly for forming composite materials.

### DESCRIPTION OF THE DRAWINGS

Preferred aspects of the present invention will now be described with reference to the accompanying drawings, in which:

FIG. 1 is a micrograph showing a pore structure in a tibial plate which can be reproduced by a process according to the present invention;

FIG. 2 shows a typical layer structure achievable according to the invention;

FIG. 3 is a schematic illustration of a general layout of a direct write process according to the invention, and

FIG. 4 is a schematic illustration of a general layout of a printing head and cooled substrate used in the direct write process according to the invention

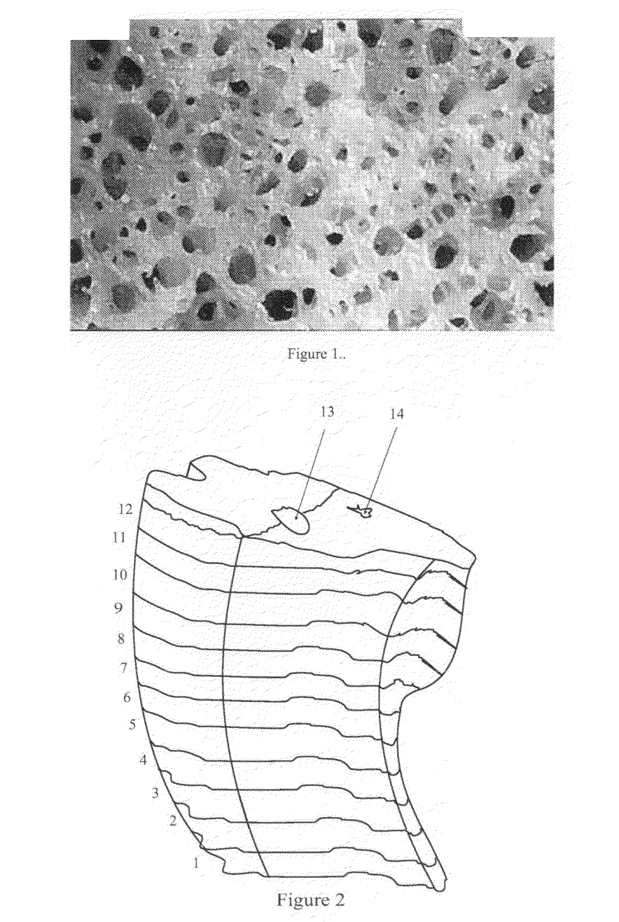

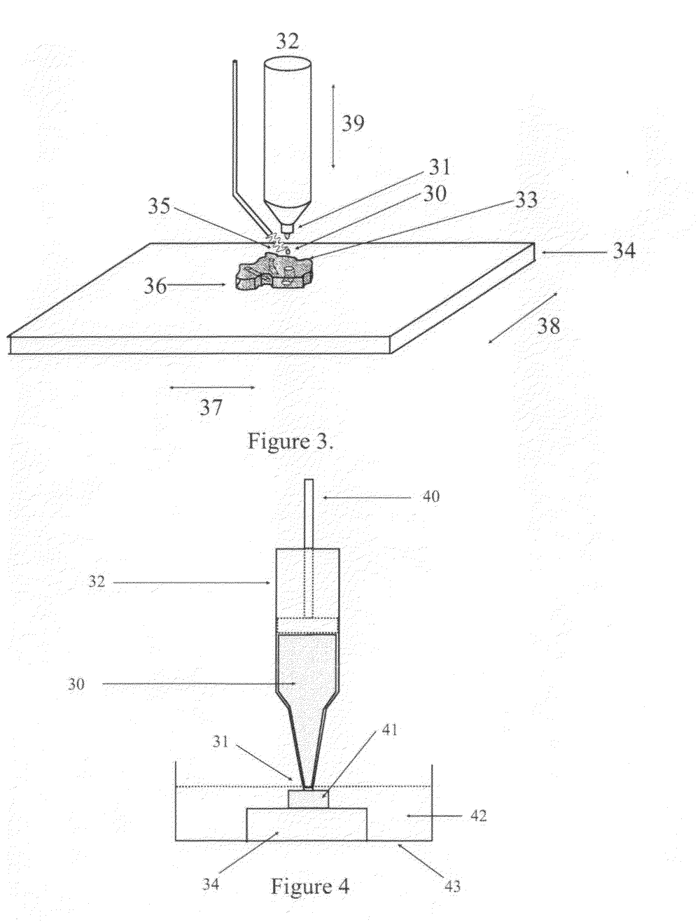

In more detail, FIG. 3 shows a schematic representation of an exemplary direct write process showing the liquid composition 30 writing from the outlet nozzle 31 of a dispenser 32 on to a substrate 34, where liquid from the nozzle impinges to form a layer 33. The freeze gelation of the liquid composition is achieved by contact with a jet of liquid nitrogen 35 directed at the point of contact of where the liquid composition writes initially onto the substrate 34 and subsequently on to the growing freeze cast article 36; the write pattern being achieved by the three orthogonal movements (37, 38, 39) of the substrate 34 and the dispenser 32, all such movements being controlled by a computer program.

Also in more detail, FIG. 4 is a schematic representation of an exemplary direct write unit as employed in the process according to the invention. Like parts to those in FIG. 3 are denoted by like reference numerals. In more detail, a liquid formulation 30 is dispensed from an outlet nozzle 31 of a dispenser 32. In the embodiment shown, the dispenser includes a head activated by a plunger 40. The liquid is dispensed from outlet nozzle 31 towards the substrate 34 to produce a growing freeze cast implant 41 which is barely immersed in a cold fluid 42 in a container 43. The cold fluid freezes the liquid formulation and as the growing implant layer 41 is complete, the implant moves away from the outlet nozzle 31 by one increment and the level of the cold fluid is re-established at the surface of the next growing layer.

### PREFERRED ASPECTS OF THE PRESENT INVENTION

Preferred embodiments of the present invention are illustrated in the following worked examples.

In the following Examples, HAP powders were obtained from Plasma Biotal Ltd and percentages are expressed in weight percent. Silica sols were mainly Morrisol AS 2040 which were aqueous sols containing 40% silica particle of 20 nm particle size stabilised with ammonia. Carbon sol is Metalflo 4000 which is a Rocol colloidal graphite in water with 21% graphite. The preferred wetting agent for the silica sols is Dispex A40 which is an ammonium polyacrylate available from CIBA Chemicals.

### Example 1

A composition based upon hydroxyapatite and suitable as a bone scaffold system with high porosity was prepared by mixing the following:

50% P263S HAP fully sintered, monomodal particle size distribution <10 μm
50% PS221S BM168 fully sintered, ball milled, bimodal <20 μm

These powders were tumbled in a jar mill without grinding media for 2 hours. A liquid mixture was mixed together using a high shear mixer, using the following proportions:

### 47% Morrisol AS 2040

### 47% Water

### 5.6% Glycerol

### 0.4% Dispex A40

The HAP powder mixture was ground with the liquid mixture in proportions of 73% powder to 27% liquid in a mortar and pestle on a vibration table until the mixture was fully wetted and flowed under vibration. This mixture was introduced into a syringe with a diameter of 2 mm in which the plunger was connected to a stepping motor which could be controlled by a computer so it could dispense a controlled amount of material by volume over a period of time.

The substrate was an aluminium plate with cooling channels through which passed liquid nitrogen and whose surface was treated with a mineral oil to aid release of the frozen component. The syringe (dispensing head) was fixed to a mechanism in which the X, Y, and Z movement could be controlled by a computer. Linking this movement control with that of the dispensing head via appropriate software, it was possible to programme the system to write geometrical shapes which were built up from layers as previously described. As the stream of ceramic slurry contacted the cold substrate, it froze and irreversibly solidified. Likewise as the solidified layers built upwards each subsequent layer froze to the previous one. Once the component was built the frozen part was removed from the substrate and allowed to return to room temperature at which point it remained solid. This part was then fully dried in a convective oven at 40° C. then finally loaded into a kiln and fired to 1250° C. by raising the temperature by 5° C. per minute and holding at peak temperature for 1 hour. After firing this ceramic contained 21% porosity and was suitable as a body-absorbable scaffold material. The strength of this ceramic material was 33 MPa measured in biaxial tension on 12×2 mm disc samples.

### Example 2

The powders were varied in proportion from Example 1, as follows:

62.5% P263S HAP fully sintered, monomodal particle size distribution <10 μm
37.5% PS221S BM168 fully sintered, ball milled, bimodal <20 μm
and mixed with the liquid mixture from Example 1 in the identical proportions.

The procedure for direct writing this ceramic was as in Example 1 including the drying and firing of the resulting component. This ceramic had lower overall shrinkage than the material produced in Example 1 and had a fired porosity of 26%.

### Example 3

This composition used the same type and proportions of HAP ceramic powders as in Example 1 and mixed in the same way but the liquid mixture comprised:

### 47% Morrisol AS 2040

47% Metalflo 4000 colloidal graphite

### 5.6% Glycerol

### 0.4% Dispex A40

As in Example 1. the powder and liquid mixtures were mixed in proportions 73% powder to 27% liquid mixture. This mixture was dispensed through a 1 mm diameter syringe orifice and processed by direct write as in Example 1 including the drying process. The firing cycle consisted of heating to 600° C. at a rate of 3° C. per minute and holding at 600° C. for 1 hour then rising to 1250° C. at 5° C. per minute and holding at this temperature for one hour. The resulting component had inherent micro-porosity of several microns which was thought beneficial for bone growth and was too fine to be written in by the direct write process.

### Example 4

The powder composition was as follows:

65% P263S HAP fully sintered, monomodal particle size distribution <10 μm
25% PS221S BM168 fully sintered, ball milled, bimodal <20 μm
10% P263R unreacted sinterable grade HAP

This was mixed with a liquid mixture of the following composition:

### 93.5% Morrisol AS 2040

### 6% Glycerol

### 0.5% Dispex A40

in proportions of ceramic powder to liquid mixture of 77% to 23%. The component was processed by direct write and dried as in Example 1. The component was sintered by heating at 5° C. per minute to 1350° C. and holding for 1 hour. This gave a fully dense sample with porosity of 0%. This was suitable as a structural bone implant having a strength of 106 MPa.

### Example 5

The powder mixture in Example 4 was used and mixed with the following liquid mixture:
86% Morrisol AS 2040
9.6% Vinamul 3469 vinyl acetate-vinyl chloride-ethylene copolymer diluted 1:2 with water
4% Glycerol
0.4% Dispex A40

The liquid was added to the powder mixture in proportions of 28% to 72%. The mixing was as in Example 1, but the rheology was such that the slurry passed through an orifice of 0.75 mm.

The heat treatment was as for Example 3. The resulting ceramic had strength of 29 MPa and porosity of 20%.

### Example 6

This is an example of a higher strength ceramic as would be expected for a bone implant required to bear load.

All aluminium oxide powders are supplied by Almat.

10% CT 3000—fine ground aluminium oxide <10 μm BET surface area 3.8 m²/g
90% CT9FG<50 μm aluminium oxide. BET surface area 0.6 m²/g

This was mixed with a liquid mixture as follows:

### 78% Morrisol AS 2040

6% Vinamul 3171 diluted 1:2 with water

### 6% Glycerol

### 9.5% Water

### 0.5% Dispex A40

The liquid and powder mixtures were mixed in proportion of 20% to 80%.

Direct write conditions were as for Example 1, and also the drying conditions. The component was fired to 1400° C. at 3° C. per minute and held for 1 hour.

### Example 7

This was a structural ceramic which could be used to make large components such as ceramic dies and tools and which flowed effectively through a dispensing orifice of 10 mm.

The powders are mixed as follows:

60% 48-200 mesh tabular alumina
25%—325 mesh aluminium oxide

### 7.5% CT9FG

### 7.5% CT3000

The powders were mixed with the following liquid mixture:

### 93.6% Morrisol

### 6% Glycerol

### 0.4% Dispex AS 2040

The liquid and powder mixtures were blended together in the proportions of 16% to 84%.

A pneumatic dispensing gun was used to produce a stream of material. The material was written on to a cooled ceramic foam substrate and additional cooling was provided by a jet of liquid nitrogen directed to the point where the stream of slurry contacted the substrate. In this example the composition was built up at only one layer thickness.

The finished component was allowed to reach room temperature over two days then gradually dried in a convective oven in which the temperature increase from 40 to 60° C. over a period of three days. The component was then fired to 1100° C. at a rate of 2° C. per minute and held at peak temperature for two hours.

### Example 8

This composition was designed to be based upon non-aqueous liquids which gave a slurry of low viscosity capable of dissolving polymer rheology modifiers insoluble in water. Also because of the low freezing temperature attempts have been made to write these materials under liquid nitrogen directly.

The sol systems are manufactured by Nissan Chemical Corporation and in this example one such system is. IPA-ST-L L silica particles (40-50 nm at 30-31 wt % SiO₂) dispersed in IPA.

In this example a slurry was prepared using only P263S HAP mixed with IPA-ST-L in the proportions of liquid to powder of 25% to 70% and using 5% of a rheology control modifier manufactured by Rohm Hass sold under the name of Acusol which is a synthetic hydrophobically-modified acrylate polymers and this could be dispensed through an orifice of 0.5 mm. The component made by direct write was a simple layer structure of only one layer thickness. The freezing process used liquid nitrogen in direct contact with the slurry and substrate hence the freezing temperature was −196° C.

### Example 9

In this example, a dilute slurry was prepared by using a high shear mixer to disperse a low concentration of ceramic powder into a pure sol of Nyacol 14/30 sodium stabilised silica sol. An amount of 0.9% of Taimicron TM-DR low temperature sinterable aluminium oxide was mixed into 99.1% of the sol. This liquid mixture was dispensed as droplets through a syringe with diameter of 200 μm and a single layer pattern was written onto a cooled alumina ceramic substrate. This pattern written was no more than 50 μm thick and was dried by evaporation at room temperature. The pattern was then sintered in a furnace at 1100° C. leaving the pattern sintered and adherent to the substrate. The material of the pattern contained a high degree of sub-micron porosity and, as such could find uses in applications such as sensors.

1. A process of preparing a green shaped article, the process comprising the following steps:
a) providing a substrate at an initial predetermined spacing from one or more liquid dispensing outlets;
b) writing a predetermined amount of a liquid formulation from at least one of said outlets onto the substrate, said formulation comprising:
8 to 99.99% by weight of a liquid sol comprising a liquid carrier and from 5 to 50% by weight, based on the weight of the carrier, of colloidally dispersed nanoparticles having a mean particle size in the range 0.25 to 100 nm;
92 to 0% by weight of a mineral powder having a mean particle size greater than 0.1 micron, and
0.01 to 10% by weight of at least one ingredient selected from surfactant, freezing point depressant and rheology modifier;
c) providing cooling to said liquid formulation on the substrate so as to permit at least partial freezing of the carrier on the cooled substrate;
d) increasing the spacing between the one or more dispensing outlets and substrate to a further predetermined spacing;
e) writing a further predetermined amount of the liquid formulation from at least one of said outlets either on to the substrate or on to deposit formed in steps b) and c);
f) providing cooling to said liquid formulation on the substrate or on the deposit so as allow at least partial freezing of the liquid carrier on at least one of the substrate and the deposit; and
g) optionally repeating steps (d), (e) and (f) one or more times.

2. A process according to claim 1, wherein the liquid carrier comprises water, optionally containing glycerol.

3. A process according to claim 2, wherein the liquid formulation is cooled below the freezing temperature of said liquid carrier in at least one of step c) and step f).

4. A process according to claim 1, wherein the liquid formulation is cooled to a temperature between −5° C. and −196° C. in at least one of step c) and step f).

5. A process according to claim 1, wherein in step b) and/or e) said predetermined amount is controlled by a microprocessor which acts on the or each respective liquid outlet.

6. A process according to claim 5, wherein the or each said outlet is a printer head driven by a motor controlled by said microprocessor.

7. A process according to claim 1, wherein steps b), d) and/or e) are controlled by memory means storing information relating to shape, internal geometry and dimensions of the desired green shaped article.

8. A process according to claim 1, wherein said formulation is written onto said substrate in at least one of step b) and step e) in the form of droplets.

9. A process according to claim 1, wherein said mineral powder comprises at least one of alumina, silica, zirconia, silicon carbide, silicon nitride, tricalcium phosphate and hydroxyapatite.

10. A process according to claim 1, wherein said nanoparticles comprise at least one of silica, alumina, carbon, zirconia, yttrium oxide, titanium dioxide, and hydroxyapatite.

11. A process according to claim 1, further comprising applying a growth factor to said green shaped article.

12. A process according to claim 1, wherein the chemical composition of said mineral powder is substantially identical to that of the nanoparticles.

13. A process according to claim 1, further comprising the step of firing or sintering said green shaped article.

14. A process according to claim 1, wherein step d) comprises displacing at least one of said outlets to a position more remote from said substrate.

15. A process of producing a prosthesis or implant for an animal body, which comprises producing a stored computer model of said prosthesis or implant based on scans or readings obtained from a patient, and producing a facsimile of the stored computer model by a process according to claim 1.

16. A biocompatible prosthesis or implant, which comprises a monolithic body built up as a plurality of layers at least some of which are discontinuous, each said layer being formed from nanoparticles of mineral material, and optionally mineral powder, bonded together essentially by Van der Waals forces and being substantially free of organic binders.

17-18. (canceled)

19. A prosthesis or implant according to claim 16, wherein said nanoparticles are selected from the group consisting of silica, alumina, carbon, zirconia, yttrium oxide, titanium dioxide and hydroxyapatite.
